(19) United States
(12) Patent Application Publication
(10) Pub. No.: US 2013/0060601 A1
(43) Pub. Date: Mar. 7, 2013

(54) PRIVACY-PRESERVING ADVERTISEMENT TARGETING USING RANDOMIZED PROFILE PERTURBATION

(71) Applicants: Muralidharan S. Kodialam, Marlboro, NJ (US); Tirunell V. Lakshman, Morganville, NJ (US); Sarit Mukherjee, Morganville, NJ (US)

(72) Inventors: Muralidharan S. Kodialam, Marlboro, NJ (US); Tirunell V. Lakshman, Morganville, NJ (US); Sarit Mukherjee, Morganville, NJ (US)

(73) Assignee: Alcatel-Lucent USA Inc., Murray Hill, NJ (US)

(21) Appl. No.: 13/225,878

(22) Filed: Sep. 6, 2011

(51) Int. Cl. G06Q 30/00

(52) U.S. Cl. 705/7.29

(57) ABSTRACT

A distribution and scheduling system for advertisements that targets ads to users and maximizes service-provider revenue without having full knowledge of user-profile information. Each user device stores a user profile and is pre-loaded with a set of ads that could possibly be shown during a timeslot. Each user device selects and displays an ad based on the user profile but does not identify the selected ad to the service provider. Instead, the user devices provide perturbed user-profile information in the form of Boolean vectors, which the service provider uses in conjunction with a guaranteed-approximation online algorithm to estimate the number of users that saw a particular ad. Thus, the service provider can charge advertisers for the number of times their ads are viewed, without knowing the users' profiles or which ads were viewed by individual users, and users can view the targeted ads while maintaining privacy from the service provider.

### BACKGROUND OF THE INVENTION

1. Field of the Invention

This invention relates generally to the field of targeted advertisements (or “ads”) for television, web browsing, and other media, and, in particular, to an ad distribution and scheduling system that targets ads to users while keeping users' profile information private.

2. Description of the Related Art

This section introduces aspects that may help facilitate a better understanding of the invention. Accordingly, the statements of this section are to be read in this light and are not to be understood as admissions about what is prior art or what is not prior art.

Effective targeting of ads to users has become an increasingly important revenue-generating service. In order to target appropriately and accurately, a service provider must have access to users' interest profiles. Ad targeting, pioneered by Google's AdWords, began as a service that targeted ads based solely on users' search keywords. However, today, more and more service providers are leaning towards the use of user profiles to better target users, even in the absence of any search keyword. For example, Google's AdSense can serve and place different ads into a website's page based on the identity of the user that has requested that page. Usually, as a user browses different websites, a service provider creates and maintains a user profile, and stores that profile within its infrastructure. In this scenario, the service provider has full knowledge of and complete access to each user's activities and interests. This arrangement puts ad targeting and user profiling at odds with user privacy.

In one conventional scheme for targeting ads, an advertiser expresses the kind of users it is interested in targeting for a given ad by specifying a bid per user profile for that ad. The service provider matches the ad against the user profiles to select the best ad to show a user, and the selected ad is then shown to the user. Then, the service provider charges the advertiser the bid amount for each display of the ad.

In the foregoing scheme, the service provider has knowledge of users' profiles, including which ads are delivered to which users, and charges the advertiser based on that information. There is a need, however, to target ads in a manner that preserves the privacy of users, while still permitting advertisers to be charged according to the frequency at which their ads are shown.

### SUMMARY OF THE INVENTION

Certain embodiments of the present invention employ a methodology for targeting ads in a manner that preserves the privacy of users.

In order to target ads in a privacy-preserving fashion, certain embodiments of the present invention significantly depart from the conventional targeted ad-distribution model by addressing the following two privacy-related needs: First, there is a need for user profiles to be created and maintained in such a way that the service provider cannot access them. Second, there is a need for the service provider to be able to garner information about how many users saw a particular ad, so that it can charge the advertisers appropriately, yet without knowing which ads were displayed to which users.

In certain embodiments of the invention, in order to preserve user privacy, the user profile does not reside within the service provider's infrastructure, but rather, is housed in a device under the user's control and desirably on a device that will ultimately display the ad. Such devices include, e.g., the user's personal computer (PC), mobile telephone, residential gateway, or set-top box (STB). In a home network, it is assumed that, if the user's device is a residential gateway, then the ad will be displayed on the user's networked TV or PC. The profile-creation process can be computation-intensive and can also generate additional network traffic. Although current-generation user devices have adequate processing power and memory, technical or business reasons can limit the network throughput of such devices. For example, bandwidth usage in a wireless network might be restricted on a monthly basis, and the uplink bandwidth of a DSL connection is far lower than its downlink bandwidth. Therefore, one challenge is to create the profile in a manner that is appropriate for, and commensurate with the resources available to, the user device.

Assuming that the user's profile is created and maintained in a privacy-preserving fashion in the user's own device, the next step is to leverage the profile information to target ads to the user. Even after the profile has been prepared in a privacy-preserving fashion, it would compromise the user's privacy if the user's device were to send the profile out to the service provider or to any other third party, trusted or untrusted, in order to make an appropriate ad selection. Thus, the profile information cannot be permitted to leave the user's device at any time, in any form, to any other device.

One method for keeping profile information hidden is to employ a role reversal, as follows. Instead of sending the profile to the service provider and having the service provider determine which set of ads could be of interest to a particular user, the service provider can send to the user device the profile parameters in which the advertisers are interested, and then allow the user device to determine the set of ads that are of interest to the user. Information about the set of ads that a particular user is interested in is then provided to the service provider, who delivers those ads to the user device for display at appropriate time. It should be recognized that, if a user device identifies a set of ads of interest to the service provider, then the user's privacy regarding his or her preference information is at least partially compromised. For example, if a user device announces to the service provider that the user is interested in seeing ads for Audi cars and Budweiser beer, then it can be inferred that the user is interested in cars and alcoholic beverages.

One goal of certain embodiments of the present invention is to avoid sending any user preference-related information to the service provider that would permit the service provider eventually to construct a profile. To accomplish this goal, the process of ad targeting (e.g., the users) is decoupled from ad billing (e.g., the service provider). In the conventional method, ad targeting and ad billing are necessarily intertwined, since the service provider charges advertisers based on the ads that are shown to the user. It is noted that, in order to charge the advertiser properly, all that the service provider needs to know is the number of users who view a particular ad, and not the identity of those individual users.

In certain embodiments of the invention, a relevant time period is divided into epochs (e.g., a day, 6-hour intervals, or a week). It is assumed that the user's profile may change during the epoch but is updated only at the beginning of the epoch. The service provider loads the user's device with a set of ads that can be shown during the epoch. Although it is conceivable that the set of ads is the set of all ads that the service provider carries, in practice, the set of ads loaded onto the user's device will be a smaller subset of the set of all ads carried by the service provider. At a given moment in time, the user device chooses an ad from the set that satisfies his profile, and the ad is displayed to the user. The user device, however, does not notify the service provider which ad the user saw. Instead, the service provider estimates the number of users that saw a particular ad using some different information. To obtain this estimate, the service provider sends the user devices the profiles in which the advertisers are interested. Each user device evaluates the appropriateness of each of these ads, which results in the construction of a Boolean vector. Instead of sending the Boolean vector in its ordinary form, a user device probabilistically perturbs each entry in the vector (e.g., by converting an entry of 0 to an entry of 1 based on a given first probability, and by converting an entry of 1 to an entry of 0 based on a given second probability, where, in various embodiments, the first and second probabilities could be the same or different), and then sends the perturbed vector to the service provider. The service provider then estimates the number of true l′s for each ad and, for billing purposes, uses that estimate as the number of users who saw that ad. This way, the service provider is able to charge the advertiser for each showing of the ad without knowing the users' profiles, and users can see the targeted ads without disclosing their preferences. Accordingly, it is important to ensure that the service provider is able to accurately estimate the number of users from the perturbed profile vectors that the user devices send.

Certain embodiments of the invention provide an architecture and methodology for creating a user profile (based on the user's web-browsing and TV-viewing habits) in a privacy-preserving fashion at the user's own device. Certain embodiments of the invention employ an ad-scheduling mechanism that can target ads without full knowledge of user-profile information, while maximizing a service provider's revenue. In certain embodiments, a privacy-preserving ad scheduler employs a guaranteed-approximation online algorithm that improves conventional online approaches for displaying targeted Internet ads. This algorithm lends itself well to protecting privacy by separating the service providers from the users. The user devices in the system use a randomized-response technique to provide perturbed profile information to the scheduler. Certain embodiments of the invention employ a novel randomized perturbation scheme that performs one to two orders of magnitude better than standard approaches for estimating the number of users who view an ad, in addition to providing improved privacy protection relative to conventional approaches. A system consistent with certain embodiments of the invention can be used effectively to target ads in a privacy-preserving manner without requiring a trusted third party. Therefore, schemes consistent with certain embodiments of the invention are suitable for even “triple play” (e.g., combined phone, TV, and Internet) service providers, cellular-phone service providers, and “over-the-top” service providers (i.e., providers whose services are overlaid over one or more third-party networks). Such schemes ensure that the service provider cannot obtain specific information about the user's activities or access the user's profile, thereby promoting user privacy.

In one embodiment, the present invention provides a computer-implemented method for estimating the number of user devices, from among a set of user devices, showing a target advertisement from among a plurality of candidate advertisements during a timeslot. The method includes: (a) the computer sending, to each of the user devices in the set, identification of the plurality of candidate advertisements capable of being shown during the timeslot by the user device; (b) the computer receiving data from a plurality of the user devices, wherein: (i) the number of user devices showing the target advertisement from among the plurality of candidate advertisements during the timeslot is capable of being estimated based on the data received from the plurality of user devices; and (ii) the identity of the user devices showing the target advertisement during the timeslot is incapable of being determined based on the data received from the plurality of user devices; and (c) the computer estimating, based on the data received from the plurality of user devices, the number of user devices showing the target advertisement during the timeslot.

In another embodiment, the present invention provides a user device-implemented method for generating data for estimating the number of user devices, from among a set of user devices, showing a target advertisement from among a plurality of candidate advertisements during a timeslot. The method includes: (a) the user device receiving identification of the plurality of candidate advertisements capable of being shown during the timeslot by the user device; (b) the user device generating data, wherein: (i) the number of user devices, from among the set of user devices, showing the target advertisement from among the plurality of candidate advertisements during the timeslot is capable of being estimated based on the data from a plurality of the user devices; and (ii) the identity of the user devices showing the target advertisement during the timeslot is incapable of being determined based on the data from the plurality of the user devices; and (c) the user device providing the data to a computer adapted to estimate, based on the data from the plurality of user devices, the number of user devices showing the target advertisement during the timeslot.

In a further embodiment, the present invention provides a system including a computer and a set of user devices in communication with the computer. The computer is adapted to: (i) send, to each of the user devices in the set, identification of a plurality of candidate advertisements capable of being shown during a timeslot by the user device; and (ii) receive data from a plurality of the user devices. The number of user devices, from among the set of user devices, showing a target advertisement from among the plurality of candidate advertisements during the timeslot is capable of being estimated based on the data from the plurality of user devices. The identity of the user devices showing the target advertisement during the timeslot is incapable of being determined based on the data from the plurality of user devices. The computer is adapted to estimate, based on the data from the plurality of user devices, the number of user devices showing the target advertisement during the timeslot.

### BRIEF DESCRIPTION OF THE DRAWINGS

FIG. 1 is a system diagram illustrating two exemplary categories of methods for profiling users based on their web-browsing activities;

FIG. 2 is a system diagram illustrating an exemplary privacy-preserving scheduler consistent with one embodiment of the present invention, wherein each user device provides a perturbed profile to the scheduler in each time slot; and

FIG. 3 is a flowchart of an exemplary privacy-preserving scheduling scheme consistent with one embodiment of the present invention.

### DETAILED DESCRIPTION

### Privacy-Preserving Profile Creation

FIG. 1 illustrates two exemplary categories of methods for profiling users based on their web-browsing (or TV-watching) activities: Cookie-based tracking (shown in solid lines) and session inspection (shown in broken lines). In cookie-based tracking, a user's browsing activities are tracked by the service provider using one or more files (referred to as “cookies”) that a browser running on the user device 101 sends via a network 104 to one or more web servers 102 currently being browsed by the user. In a session inspection-based approach, traffic originating from the user device 101 (e.g., PC, residential gateway, TV, or mobile phone) is inspected at a remote server 103 (e.g., a deep-packet inspection device or a web proxy) to determine which websites the user is visiting. A user profile is then created based on information including, e.g., the type of websites visited, the frequency of visits, click through rates, and the like.

Whichever method is used for collecting information about a user's browsing activities, the profile created from the information is conventionally maintained by the service provider within its infrastructure. Although the provider might allow the user to “opt in” to the profiling scheme or to view and/or modify the profile information, the bottom line is that the user does not have any explicit control over the profile, and the profile does not stay with the user. This, of course, can result in a lack of user confidence about the usage or possible misusage of the user's profile information. Certain embodiments of the invention eliminate such concerns by creating and maintaining the user's profile within the user's device, never allowing the profile to leave the device. Not only should the service provider be prevented from accessing user profiles, but the service provider should also be prevented from making inferences that allow the service provider to “guess” information contained in the user profiles. It is further assumed herein that the service provider either does not collect or is prohibited (e.g., by law) from collecting, any user-related information from the network.

Further details of creating a profile reflecting user interest, in certain embodiments of the invention, will now be discussed. A user typically visits several websites during a browsing session. For purposes of constructing a user profile, each of these sites can be categorized by a few representative words, which will be referred to as “classifiers.” For example, classifiers for www.cnn.com and www.edmunds.com might be {news, world news}, and {car, user car}, respectively. A user's interest can be expressed as a set of classifiers representing the websites visited by the user. Since some classifiers might appear more than once, e.g., due to the user visiting the same website multiple times or visiting websites similar in nature, a score in the form of a weight between 0 and 1 is assigned to each classifier to show its relative importance to a given user. For example, a user with an interest in cars and football could have a profile of {(car, 0.4), (sports, 0.7)}, which indicates that the user is more interested in sports than cars.

In certain embodiments of the invention, the creation of a user's profile involves the following three steps: First, data reflecting website visits and click-through rates is collected. Second, websites are mapped into one or more classifiers that reflect the properties of the site. Third, the classifiers, along with the frequency of corresponding website visits, are used to create a user's profile which includes a set of (classifier, score) pairs. During this third step, it is also possible to “age” the user's interests so that recent interests are more heavily weighted (i.e., have a higher score) than past ones.

The crux of profile computation is to assign a small set of appropriate classifiers to each of a plurality of websites. The profile is desirably created and maintained in real time in a user device using the least amount of resources. Therefore, the procedure to classify a website should be either simple and effective, or else be performed by a device other than the user device, such as by a server with large processing and memory resources and good network connectivity.

In certain embodiments of the invention, a user profile is created in the user's device, e.g., a PC, mobile phone, set-top box, residential gateway, television, and the like. Any modern versions of the foregoing devices can easily perform the first and third steps of the profile-creation process. However, the second step could possibly exceed the capabilities of such devices, and therefore, such devices might be assisted by an offsite server configured to return a set of appropriate classifiers for a website upon request. With such outside assistance, however, the second step risks potentially leaking profile-related information to the service provider. The resultant privacy concerns desirably can be addressed using, e.g., one of the following two exemplary methods, referred to as a device-centric method and a provider-assisted method.

In a device-centric method, the user device is responsible for assigning keywords to a website. A web server sends an html page to a browsing user's device in response to the user device's request to receive the page. When the page passes through the user device, the user device executes a software routine that examines and assigns classifiers to the page. A lightweight method for assigning classifiers uses metadata (e.g., title, keywords, description, and the like) contained within the web page. This method introduces little additional workload for the user device and can be easily handled by most of the current generation of devices, even by a mobile phone. This method neither creates any new network traffic nor divulges any user-specific information to the service provider. The only drawback is that the classifiers might not always correctly correspond to a web page's actual content, because this method of assigning classifiers depends solely on the information chosen at the whim of the page creator. On the other hand, if the user device has sufficient processing power and unlimited and fast network access (e.g., a PC with a broadband connection), then the user device could be adapted to perform a more resource-intensive method for assigning classifiers.

In a provider-assisted method, the user device consults a network-resident server, referred to as a Classifier Database Server (CDS) or sometimes as a Keyword Database Server (KDS), to assign classifiers to a website. The function of a CDS is to fulfill a request from a user device to provide a set of classifiers for a website, based on an algorithm. CDS functionality could be provided by a network service provider or over-the-top service provider or, alternatively, could be implemented in a public server. There can be a number of CDS servers, belonging to different owners, distributed across the network. In this scenario, the user device securely sends the uniform resource locator (URL) of the web page requested by the user to a randomly-selected CDS, which, in response, returns the classifiers assigned to the web page identified by the URL. The provider-assisted method reduces the computing load on the user device and introduces only a relatively small load on the network during communications between the user device and the CDS. To reduce the impact of this load even further, query traffic can be assigned a low priority so that it does not interfere with other network traffic, or queries can be made during off-peak hours. The contents of the query, however, can still leak some user-related information to the service provider by informing the CDS about which websites a user has visited. In order to prevent such information leakage, one of the three following exemplary mechanisms can be used: randomization, provider's anonymizer, and public-domain anonymizer.

Randomization: In this method, a CDS responds to two types of requests from a user device: (i) requests for a default set of classifiers and (ii) requests for classifiers for a specific set of websites. When a user device requests a default set of classifiers, the CDS replies with classifiers corresponding to some set of web pages frequently accessed by the user population as a whole. This set of web pages could contain, e.g., the most frequently-requested pages, the least frequently-requested pages, the top hundred web pages requested during the last few hours, combinations of the foregoing sets of web pages, and the like. The user device caches this information. If the user visits any website from this set, then the user device need not send an explicit request to the CDS, and no user-specific information is leaked to the service provider. If a website visited by the user falls outside the set, then the device randomly decides whether or not to send a request for this site to a CDS. If the device decides to send a request, then the device augments the request with several additional carefully-chosen websites that the user has not actually visited. In this manner, the provider does not ever know exactly which of those several websites the user has visited. If multiple CDSs are accessible by the user device, then the device might choose to distribute queries to different CDSs, so that no single CDS ever obtains enough information about the user to recreate a profile. It is noted that this method might create some additional network traffic (e.g., a few hundred bytes per request) and might provide the service provider with some vague idea of user's web surfing behavior.

Provider's anonymizer: In this method, the provider places a CDS behind a Network-Address Translation (NAT) device. When a user device needs a website-to-classifier mapping, the user device makes a secure request (e.g., over a secure-socket layer (SSL)) to the CDS. The SSL session passes through the NAT device, which process exposes one or more Internet-protocol (IP) addresses, not related to any user device, to the CDS. The CDS provides its response back to the user device securely via the SSL session. Since the CDS is not ever exposed to the user device's original IP address, the CDS does not know which user device made the request. Because the request and response are transmitted via an SSL, the NAT device does not know which web pages the user device has requested. In this manner, no user-related information is exposed to the service provider. This method does not create any additional traffic load into a network other than bandwidth associated with requests for the websites that the user actually visits. It is noted, however, that, if the NAT device and the CDS are under the control of the same party, then it might be possible to determine the websites visited by a user.

Public-domain anonymizer: In this method, the user device uses any public-domain or third-party “trusted” anonymizer to contact a CDS. This method can be used, e.g., in the event the user is not satisfied with or does not trust the privacy offered by providers employing other methods. Since it is relatively unlikely that a provider would collude with a public-domain or third-party anonymizer, this arrangement prevents the CDS from knowing the requests made by a user device. While this method improves privacy, all requests and responses generate additional bandwidth as they are routed across the Internet to and from the anonymizer.

After mapping a website to a set of classifiers, the user device computes the score for a classifier based on the frequency of visits to the corresponding website. It is noted that information about the frequency of visits to a particular website is never exposed to the service provider, and therefore, it is impossible for the service provider to replicate the user's profile accurately. Additionally, the user device also ages the profile so that newer interests receive a higher score than older interests, and the service provider is not able to compute the “aged” profile of a user.

The aforementioned methodology can also be used to create a user profile based on the user's TV channel-surfing activities, video-on-demand (VoD) requests, and similar information that passes through the STB. Modern STBs include IP connectivity for electronic program guide (EPG) downloading, VoD ordering, and the like. Therefore, the STB can perform the steps similar to those described above for profile creation and classifier assignment. In this arrangement, the STB caches the EPG information and maps the channel-surfing information to the EPG to identify which TV program a user is watching. The TV program is assigned classifiers by a database server similar to the CDS described above. The STB retrieves the classifiers from the CDS and creates a user's TV viewing profile by weighting the classifiers with the frequency of watching a given program and the duration of watching the program (e.g., the total number of minutes that the user actually spends viewing a half-hour program). Similarly, requests for video-on-demand (e.g., pay-per-view) pass through the STB, which has knowledge of which service/movie has been ordered and when. As described above with respect to a CDS, the STB uses this information to create a (classifier, score) pair relevant to the service/movie ordered by the user. If the EPG information and associated classifiers remain within the device, then a user's channel surfing activities need not be sent out to the service provider, and therefore, there is no leakage of user-pertinent information. For on-demand services, since the user can typically order from among a large choice of items, it might not be possible for the device to cache the classifiers associated with the item, in which case any of the three techniques described in the previous section (randomization, provider's anonymizer, and public-domain anonymizer) or the like can be used to gather the classifiers.

In addition to the foregoing, other possible methods for keyword generation and profile creation are described in U.S. Patent Application Pub. No. 2011/0016199, the disclosure of which is incorporated herein by reference in its entirety.

Overview of Exemplary Ad-Targeting System

In a system comprising a set of advertisers that are interested in displaying targeted ads to a group of users, each user can be described by a user profile that includes, e.g., demographic information, location information, and television and online viewing behavior. Some of the profile information, such as demographic information, could be relatively static, while other profile information, such as online surfing behavior or user location, can be dynamic. Each advertiser is interested in targeting users that have a profile containing certain information. Each advertiser specifies (i) one or more target profiles, along with (ii) a bid amount that it is willing to pay if the ad is shown to a user having a target profile, and (iii) a maximum amount of money (i.e., a budget) that can be charged to the advertiser by the service provider. Although the discussion of the methodology herein involves the advertisers specifying a single target profile, this methodology can be extended to advertisers specifying more than one target profile, with a different bid for each profile. The objective of an ad-scheduling system consistent with certain embodiments of the invention is to maximize the service provider revenue. A scheduler consistent with certain embodiments of the invention should take into account several additional objectives while attempting to maximize revenue. First, the scheduler should not assume any a priori knowledge of user profiles, user availability information, or advertisers' bids and budgets, which implies that the ad-scheduling decisions should be made in an online manner. Second, it is assumed that each user knows his or her profile information and would like to keep it private, which implies that, from a privacy perspective, a scheduling algorithm consistent with certain embodiments of the invention should operate without any knowledge of the user-profile information.

Although it might seem difficult or impossible for the scheduler to maximize a service provider's revenue in light of the foregoing two restrictions, it is indeed possible for the scheduler to optimize revenue with no a priori information about the advertisers and only probabilistic information about a user. To accomplish this goal, three different schedulers (i.e., scheduling schemes) for distributing targeted ads will be described. The first scheduler is a “complete information scheduler” that has complete knowledge of the future as well as full knowledge of user-profile information. The second scheduler is an “online scheduler” that does not know the future but still has complete knowledge of user-profile information. The third scheduler is an “online privacy-preserving scheduler” that only has perturbed (i.e., privacy-preserving) information about user profiles. These three schedulers will now be described in further detail.

Complete Information Scheduler: For this scheduler, it is assumed that all future user availability (i.e., which users will be active at which times), user profile information, and advertisers' preferences are known a priori. Given all of this information, the scheduler can formulate an optimization problem to maximize revenue and then implement this solution. Although the assumptions made in this approach are unrealistic, a complete information scheduler provides an upper bound on achievable revenue and forms the basis for the second type of scheduler, an online scheduler.

Online Scheduler: An online scheduler makes ad assignments in each time slot. This scheduler knows the set of active users in each time slot, along with their profiles, and the remaining budgets for each advertiser. By making appropriate decisions, the performance of an online scheduler is within a constant factor of the performance of a complete information scheduler. This approach satisfies the first objective of maximizing revenue without a priori information. However, this approach assumes that all user profile information is exposed to the scheduler. The third type of scheduler modifies the online algorithm in order to mask user-profile information.

The online scheduler described above is characterized by two primary characteristics: (i) the online scheduler orders ads based on bid and other parameters that the scheduler computes, and (ii) each user device displays the first ad in an ordered list that matches the corresponding user's profile. Important information that the online scheduler needs from the user devices in each time slot includes the total number of users who have viewed each ad, without requiring knowledge of the users' identities. Considering a system in which (i) all ads are preloaded to each user device, and (ii) the user profiles are known only to the user devices, each user device can easily determine which ad to display in each time slot. A disadvantage of implementing the online scheduler, however, is the fact that the scheduler does not know how many users watched each ad, for purposes of determining how much to charge the advertiser.

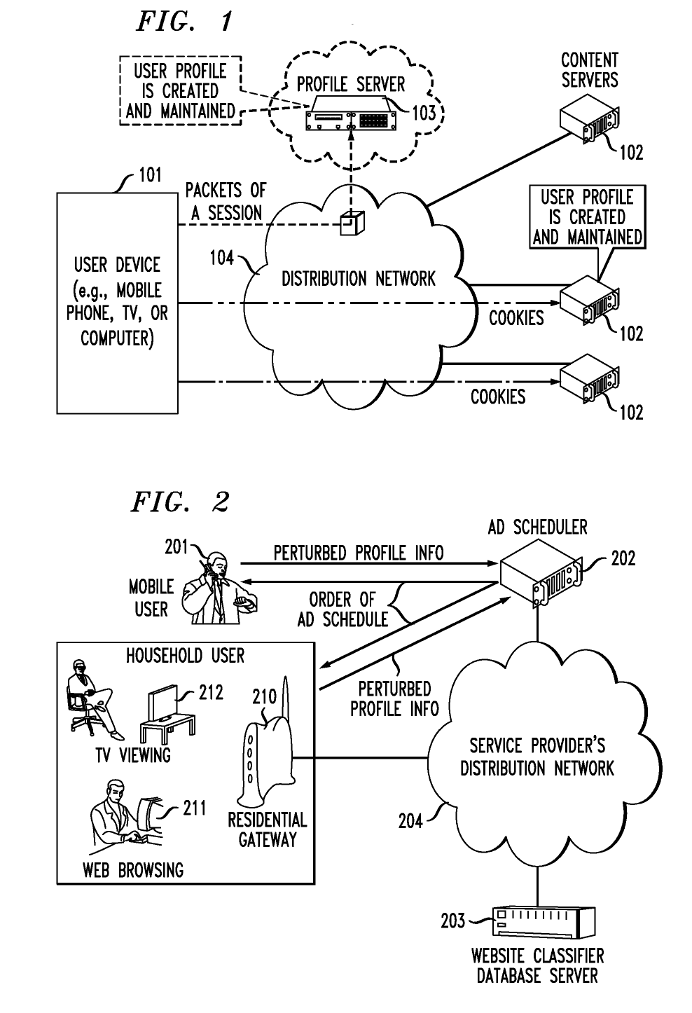

Privacy-Preserving Scheduler: FIG. 2 illustrates an exemplary privacy-preserving scheduler 202, wherein one or more users (e.g., using a mobile device 201 or a residential gateway 210 connected to a PC 211 or a TV 212) provide a perturbed profile to scheduler 202 in each time slot. (In some embodiments, a privacy-preserving scheduler provides the perturbed profile only when there has been a change in the profile.) Scheduler 202 is in communication with a CDS 203 via a network 204. As will be described in further detail below, the scheduler can estimate how many users viewed each ad in each time slot without knowing which ad a given user has viewed, such that advertisers can be charged appropriately while preserving the privacy of the users.

### User Profile and Ad Appropriateness

As stated earlier, in certain embodiments of the invention, a profile for a user includes both static and dynamic information about the user, and each advertiser bids on users whose profiles have a given combination of profile elements. For example, an advertiser might want to target a group of users living in a particular locality who have searched for a car on the Internet during the past week. Therefore, the profile of interest to an advertiser could include a combination of several elements of user behavior. If the user device tracks its user's own profile, it is relatively easy for the user device to know whether the user is a target for a given ad. Accordingly, if a user j meets the target profile specified by an ad i, then it can be said that user j is “appropriate” for ad i. The “appropriateness” of ad i for user j at a given time t is represented by a binary variable Aᵢⱼ(t), where:

$${A}_{ij} ( t ) = \{ \begin{matrix}1 & User j fits the profile for ad i at time t \\ 0 & Otherwise .\end{matrix}$$

The definition of an appropriateness vector Aᵢⱼ(t) includes an explicit time index, since a user's profile, as well as an advertiser's target, can change over time. If the value of appropriateness vector Aᵢⱼ(t) is known to the scheduler, then the scheduler also knows that the user meets all of the profile elements specified by the advertiser associated with ad i. Therefore, an objective of the user is to keep the value of appropriateness vector Aᵢⱼ(t) private. In the first two schedulers described in the next sections (i.e., the complete information scheduler and the online scheduler), the values of appropriateness vector Aᵢⱼ(t) are assumed to be known to the schedulers. However, this assumption is relaxed for the privacy-preserving scheduler.

### Complete Information Scheduler

The formulation of the problem of ad scheduling and optimizing ad revenue will now be discussed. In a system that includes n different ads (for simplicity, it will be assumed that each advertiser is associated with a given ad i), it is assumed that ads are scheduled over T time slots, which are indexed by t=1, 2, . . . T. The variable S(t) denotes the set of “active” users in time slot t, wherein a user is said to be active in a time slot if the user is viewing a device that can display an ad in that time slot. It is assumed that the advertiser associated with ad i is willing to pay bₜ(i) for displaying the ad to any user j in time slot t, whose appropriateness vector Aᵢⱼ(t)=1 and j∈S(t), i.e., the user is active and fits the profile for ad i. In addition, the advertiser associated with ad i specifies a budget B(i) that represents the maximum amount of money the advertiser is willing to pay over the T time slots. In the complete information scheduler, the values of S(t), Aᵢⱼ(t), and bₜ(i) are assumed to be known a priori for all time slots t, for all users j, and for all ads i. The objective of the complete information scheduler is to determine an assignment of advertisers to users in each time slot that maximizes total revenue while respecting each advertiser's budget. The decision variables for the scheduler are binary variables Xᵢⱼ(t), where:

$${X}_{ij} ( t ) = \{ \begin{matrix}1 & User j is assigned to ad i at time t \\ 0 & Otherwise .\end{matrix}$$

The problem of maximizing revenue can be written as the following integer-programming program:

$${TR}_{CI} = max {Σ}_{t} {Σ}_{j ∈ S ( t )} {Σ}_{i \text{:} {A}_{ij} ( t ) = 1} {b}_{t} ( i ) {X}_{ij} ( t ) , \\ \begin{matrix}{Σ}_{i \text{:} {A}_{ij} ( t ) = 1} {X}_{ij} ( t ) = 1 ∀ j ∀ t , & ( 1 ) \\ {Σ}_{t} {Σ}_{j ∈ S ( t )} {b}_{t} ( i ) {X}_{ij} ( t ) \leq B ( i ) ∀ i , & ( 2 ) \\ {X}_{ij} ( t ) ∈ \{ 0 , 1 \} ∀ i , j , t , & ( 3 )\end{matrix}$$

where TR_{CI} represents the total revenue that is achieved by the complete information scheduler. Equation (1) ensures that each user is shown at most one ad in each time slot. Equation (2) enforces the budget for each advertiser. Equation (3) ensures that the decision variable is assigned for each ad i for each user j in each time slot t. Since Equations (1)-(3) form an integer programming problem, this problem is not solved directly, but rather, forms a basis for the online algorithm developed in the next section.

### Online Scheduler

An online scheduler is a primal-dual algorithm that provides an approximate solution to the complete-information scheduling problem. However, unlike typical Internet ad targeting, where a single user appears at a given moment in time, in a system employing an online scheduler, multiple users can be active in any time slot. Therefore, primal and dual updates are performed for groups of concurrent users, which enables the privacy-preserving online scheduler outlined in the next section. In order to develop the online algorithm, the linear-programming relaxation of the complete information scheduler is first considered, where upper bound Xᵢⱼ(t) is set to 0≦Xᵢⱼ(t)≦1. Upper bound Xᵢⱼ(t)≦1 is implied by Equation (1) above and can therefore be eliminated from the formulation. Now, the dual to the above linear-programming relaxation can be written as:

$$min {Σ}_{j} {Σ}_{t} π ( j , t ) + {Σ}_{i} B ( i ) δ ( i ) , \\ \begin{matrix}π ( j , t ) \geq {b}_{t} ( i ) [ 1 - δ ( i ) ] ∀ i \text{:} {A}_{ij} ( t ) = 1 , & ( 4 ) \\ π ( j , t ) \geq 0 , & ( 5 )\end{matrix}$$

where the dual variable δ(i) is unrestricted in sign. (It is noted that dual variables π(j,t) and δ(i) are merely intermediate variables used in deriving an approximation guarantee and do not have any particular significance by themselves.) From Equation (4), dual variable π(j,t) can be set to:

$$π ( j , t ) = {max}_{i \text{:} {A}_{ij} ( t ) = 1} {b}_{t} ( i ) [ 1 - δ ( i ) ] . \qquad ( 6 )$$

An online scheduling algorithm such as the foregoing solves the linear-programming relaxation of the complete information ad scheduler.

An online scheduler matches users to ads at the beginning of each time slot. It is assumed that, at the beginning of time slot t, the ad-selection algorithm has the following information: (i) the set S(t) of active users at time t, (ii) the bid bₜ(i) that the advertiser corresponding to ad i places on user j with Aᵢⱼ(t)=1, and (iii) the budget B(i) and the current remaining budget for the advertiser corresponding to each ad i. An online ad-selection algorithm outputs the assignment of each user in S(t) to exactly one ad i.

An outline of an online-scheduling algorithm consistent with one embodiment of the invention will now be described. The online scheduler described below uses a primal-dual scheme to choose the ads in each time slot.

Dual variables δ(i) are initialized to zero (δ(i)←0 ∀ i at t=1) and are updated at the end of each time slot t. The variable Nᵢ(t)=Σⱼxᵢⱼ (t) represents the number of users who view ad i at time t, and budget constraint B(i) can be rewritten as:

$${\sum }_{t = 1}^{T} {b}_{t} ( i ) {N}_{i} ( t ) \leq B ( i ) .$$

In each time slot, the online-scheduling algorithm performs three steps:

Step 1. Ad Ordering: In each time slot, the scheduler computes a permutation a of the ads such that, for k=1, 2, 3, . . . n−1, bₜ(σ(k))[1−δ(σ(k)))]≧bₜ(σ(k+1))[1−δ(σ(k+1))]. To simplify notation, it is assumed that the ads are renumbered in time slot t, such that bₜ(1)[1−δ(1)]≧bₜ(2)[1−δ(2)]≧ . . . ≧bₜ(n)[1−δ(n)[. Accordingly, in each time slot, the scheduler selects and communicates to the users an ordered list of ads computed by arranging the ads with B(i)>0 in decreasing order of bᵢ(i)[1−δ(i)].

Step 2. Ad Selection: User j selects the first ad i in the ordered list of ads, such that Aᵢⱼ(t)=1, and the user views that ad. This is done by user j computing an intermediate variable P(j) using:

$$P ( j ) = arg {max}_{i \text{:} {A}_{ij} ( t ) = 1} {b}_{t} ( i ) [ 1 - δ ( i ) ] ,$$

and setting X_{P(j)j}(t)=1 and Xᵢⱼ(t)=0 for all other i.

Step 3. Updating Budgets and Duals: The online scheduler then determines the number of users who viewed each ad and updates the dual variables. It is noted that, in this step of the algorithm, there is a constant c that is chosen according to the following Theorem (1):

Theorem (1): TR_{CI} denotes the revenue generated by a complete information scheduler, TR_{ON} denotes the revenue generated by an online scheduler, and R denotes the maximum fraction of any advertiser's budget that can be used up in any time slot. In Step 3, if c←(1+R)^{1/R}, then R_{ON}≧βR_{CI}. where:

$$β = \frac{{( 1 + R )}^{1 \text{/} R} - 1}{{( 1 + R )}^{1 \text{/} R}} ( 1 - R ) .$$

If R→0, then R_{ON}≧[(e−1)le]R_{CI}, for all possible inputs.

The dual variables π(j,t) are used in deriving an approximation guarantee but are not used in assigning ads to users. The online scheduler computes Nᵢ(t)=ΣⱼXᵢⱼ(t), which represents the number of users who view ad i in time period t, and updates the following values for budget constraint B(i) and dual variables δ(i) and π(j,t) using:

$$B ( i ) ← B ( i ) - {b}_{t} ( i ) {N}_{i} ( t ) , \\ δ ( i ) ← δ ( i ) [ 1 + \frac{{b}_{t} ( i ) {N}_{i} ( t )}{B ( i )} ] + \frac{{b}_{t} ( i ) {N}_{i} ( t )}{( c - 1 ) B ( i )} , and$$

$$π ( j , t ) ← {b}_{t} ( P ( j ) ) [ 1 - δ ( P ( j ) ) ] .$$

It is assumed that the online scheduler knows which ad was viewed by each user in each time slot. This information exposes the profile of the user to the scheduler. If the users wish to keep their profiles confidential, then they cannot reveal which ads they viewed.

It should be noted that the online scheduler has two principal operations, one performed by the users and the other by the scheduler: (i) the scheduler first orders the ads in decreasing values of bₜ(i)[1−δ(i)] and is also responsible for updating the values of dual variables δ(i), and (ii) from the ordered list, the user chooses the first ad that matches the user's profile. Since the user device knows the user's profile, if all possible ads are preloaded into the device, then the user device can choose the appropriate ad to display to the user. The online scheduler knows how many users have viewed each ad, in order to be able to update the dual-variable values, as well as to be able to charge the advertisers appropriately. However, it should be understood that the online scheduler does not need to know exactly which ad was viewed by each user, so long as the scheduler knows the value of Nᵢ(t), i.e., the number of users who viewed ad i in time period t.

The next section will introduce a privacy-preserving scheduler that minimizes the amount of user information that is exposed to the scheduler, while still enabling the scheduler to run an online-type algorithm.

### Privacy-Preserving Scheduler

A privacy-preserving scheduling scheme that permits users to hide their true profiles, while still disclosing enough information for the scheduler to determine the number of users who viewed each ad, will now be described. First, the privacy-preserving mechanism will be outlined, followed by an analysis of how the scheduler can compute the number of users who view each ad in every time slot. The following discussion assumes that all the ads are preloaded onto the user device.

The privacy-preserving mechanism works as follows. The n-dimensional vector A.ⱼ(t) is used to represent the “appropriateness” vector for user j at the beginning of time slot t. It is noted that Aᵢⱼ(t) denotes whether ad i is appropriate for user j at time t. User j's device does not disclose its appropriateness vector to the scheduler. Instead, user j's device discloses a perturbed version of the appropriateness vector, denoted by the binary vector D.ⱼ(t), which will be referred to as the “disclosed-distribution vector.” Each component of the disclosed-distribution vector is determined from the corresponding component of the appropriateness vector using, e.g., the following two-parameter perturbation procedure to achieve randomization.

A (p,γ) perturbation procedure in certain embodiments of the invention is a scheme that maps a binary variable B to another binary variable B′ such that

$${B}^{′} = \{ \begin{matrix}B & with probability p \\ 1 & with probability ( 1 - p ) γ \\ 0 & with probability ( 1 - p ) ( 1 - γ ) .\end{matrix}$$

The implementation of a (p,y)-randomization procedure uses two biased virtual “coins,” each of which randomly (or pseudo-randomly) returns either “heads” or “tails” when “tossed.” The first coin returns heads with probability p when tossed, and the second coin returns heads with probability γ when tossed.

If the first coin returns heads, then B′=B. If the first coin returns tails, then the second coin is tossed.

If the second coin returns heads, then B′=1. If the second coin returns tails, then B′=0.

In the most-general case, each component of the appropriateness vector can be perturbed using a different randomization mechanism. However, this leads to an exponential-state space for the estimation problem solved by the scheduler. Therefore, it is assumed that the perturbation of the appropriateness vector is accomplished using either a fixed perturbation method or a randomized perturbation method.

In a fixed perturbation method, all user devices employ a fixed (p,γ) probability pair to perturb each component of the appropriateness vector, and the values of p and γ are known to all user devices and the scheduler.

In a randomized perturbation method, all user devices choose their (p,γ) values from a known common distribution function. It is assumed that the values of p and γ are chosen independently, and that the p and γ distributions can be different. Once user j's device selects its (p,γ) probability pair, user j's device uses this pair of values to perturb each element of A.ⱼ.

The common probability density functions from which all user devices choose their values of p and γ are denoted using the variables p(p) and ω(γ), respectively. The scheduler also knows the distribution functions for p and γ. However, the user device does not disclose the values of parameters p and γ to the scheduler. For illustrative purposes, a scenario will be used in which the values of p and γ are chosen from uniform distributions between [l,1] and [l′,1], respectively, where 0≦l, l′≦1. The scheduler knows the values of t and t′ and the fact that the values of p and γ are chosen from uniform distributions. However, the scheduler has no knowledge of the individual values of p and γ. It is noted that randomized perturbation offers an additional layer of privacy to users, since any attack would involve estimating the perturbation parameters for an individual user.

A scheme for computing the number of users who view a given ad, which is an important step in the privacy-preserving ad scheduler, will now be discussed. The main impediment to determining the number of users who view each ad is the fact that the scheduler does not know the Aᵢⱼ(t) values. The variable Nᵢ(t) denotes the number of users who viewed ad i in time period t. It is assumed that the scheduler knows S(t), i.e., the set of active users in time slot t. The expression N(t)=Σᵢ₌₁ⁿ Nᵢ(t) is used to denote the total number of active users in time slot t. Since the number of users is computed for each time slot, the rest of this discussion will omit the variable t to simplify the notation. The variable N is used to represent the total number of active users during time slot t, and the variable \hat{N}ᵢ is used to denote an estimator for the number Nᵢ of users who viewed ad i in slot t. In each time slot, ads are ordered by the scheduler, and the ordered list of ads is sent to each user device. It is assumed that the ads are renumbered so that the ordered list is {1, 2, . . . , n }.

User j's device selects an ad to view by determining the smallest value of i such that Aᵢⱼ=1 and views the selected ad. Therefore, user j watches a given ad m if and only if:

Aᵢⱼ=0 for i=1, 2, . . . , m−1, and

Aᵢₙⱼ=1.

It is noted that, if Equations (7) were used to determine whether ad m is viewed by user j, there are potentially 2^{m-1} possible values for the variables Aᵢⱼfor 1≦i≦m−1, d in further detail below, the computational burden increases exponentially with the number of ads. Since the system can have a large number of ads, the foregoing approach is not practical and might not even be feasible.

To address this issue, a more-aggregated and equivalent condition is used for determining whether a user views ad m. Equations (7) can be restated such that the conditions for a user to view ad m are as follows:

$${\sum }_{i = 1}^{m - 1} {A}_{ij} = 0 , and \\ {A}_{mj} = 1. \qquad ( 8 )$$

If ad m is not viewed, then Equations (7) indicate exactly (i) why ad m was not viewed, and (ii) which ad that preceded ad m in the ordered list was viewed. That information is desirably kept private. To address this potential privacy problem, Equations (8) are used instead of Equations (7), so that all that can be inferred is that ad m was not viewed, since Σᵢ₌₁^{m1}Aᵢⱼ>0, and the identity of the ad that was viewed instead cannot be inferred. When determining the number of viewers for the ad, Equations (8) can be used, since all user devices select their (p,γ) probability values from the same distribution, and therefore, the values of p and γ are interchangeable. This conclusion will become apparent in the following discussion of the estimation procedure. Using Equations (8) results in a state space that grows linearly with the number of ads.

The estimation procedure for the number of users who view each ad is performed one ad at a time, typically starting from the first ad in the ordered ad list for time slot t. There are two components that are used in the estimation of the number of users who view ad m: a “reported-distribution” or “reported-data distribution” vector V(m) and a “weighting” vector W(m).

Reported-distribution vector V(m) for ad m is a 2m-dimensional vector computed from the disclosed-distribution values Dᵢⱼ provided by the users.

Weighting vector W(m) for ad m is also a 2m-dimensional vector pre-computed before the first time period. The weighting vector is a function of only the privacy-preservation mechanism based on the (p,γ) probability values and is not dependent on the disclosed-distribution Dᵢⱼ values or the ordering of the ads.

An exemplary computation of the reported-distribution vector for ad m will now be discussed. For l=0,1, . . . ,m−1, the following expressions are defined:

$${T}_{l 0} = \{ j \text{:} {\sum }_{i = 1}^{m - 1} {D}_{ij} = l , {D}_{mj} = 0 \} , and$$

$${T}_{l 1} = \{ j \text{:} {\sum }_{i = 1}^{m - 1} {D}_{ij} = l , {D}_{imj} = 1 \} ,$$

where the set Tₗ₀ represents the number of user devices that report that they have l values of 1 in the first m−1 ads and a 0 value for ad m, and the set Tₗ₁ represents the number of user devices that report that they have l values of 1 in the first m−1 ads and a value of 1 for ad m. The variable Zₗ(m) represents the probability that a randomly-chosen user belongs to the set Tₗ₀, and the variable Oₗ(m) represents the probability that a randomly-chosen user belongs to the set Tₗ₁, where:

$${Z}_{l} ( m ) = \frac{\vert {T}_{l 0} \vert}{N} , and$$

$${O}_{l} ( m ) = \frac{\vert {T}_{l 1} \vert}{N} ,$$

and N represents the total number of active users in the current time slot.

The reported-distribution vector V(m) for ad m is a 2m-dimensional vector defined as the concatenation of the values of Zₗ(m) and Oₗ(m), as follows:

$$V ( m ) = [ {Z}_{l} ( m ) , {O}_{l} ( m ) ] , with {\sum }_{i = 1}^{2 m} {V}_{i} ( m ) = 1.$$

For all values of m, an estimator for the number of viewers can be represented as a linear sum of the reported-distribution vector V(m). This 2m-dimensional vector of weights is weighting vector W(m), where:

\hat{N}=W(m)V(m)^{T}.

The components of weighting vector W(m) are not necessarily non-negative. Corresponding to the reported-distribution vector is the “actual-distribution” or “actual-data distribution” vector Y(m), which represents the actual distribution of zeros and ones as determined by the Aᵢⱼ values. The following expressions are defined:

$${S}_{l 0} = \{ j \text{:} {\sum }_{i = 1}^{m - 1} {A}_{ij} = l , {A}_{mj} = 0 \} , 0 \leq l \leq m - 1 , and$$

$${S}_{l 1} = \{ j \text{:} {\sum }_{i = 1}^{m - 1} {A}_{ij} = l , {A}_{mj} = 1 \} , 0 \leq l \leq m - 1 ,$$

where the set Sₗ₀ represents the actual number of user devices that have l values of 1 in the first m−1 ads and a 0 value for ad m, and the set Sₗ₁ represents the actual number of user devices that have l values of 1 in the first m−1 ads and a value of 1 for ad m. The variable Z̅ₗ(m) represents the probability that a randomly-chosen user belongs to the set Sₗ₀, and the variable Ōₗ(m) represents the probability that a randomly-chosen user belongs to the set Sₗ₁, where:

$${\overline{Z}}_{l} ( m ) = \frac{\vert {T}_{l 0} \vert}{N} , and$$

$${\overline{O}}_{l} ( m ) = \frac{\vert {T}_{l 1} \vert}{N} ,$$

and N represents the total number of active users in the current time slot. Actual-distribution vector Y(m) is a 2m-dimensional vector defined as the concatenation of the values of Z̅ₗ(m) and Ōₗ(m), as follows:

$$Y ( m ) = [ {\overline{Z}}_{l} ( m ) , {\overline{O}}_{l} ( m ) ] , with {\sum }_{i = 1}^{2 m} {Y}_{i} ( m ) = 1.$$

Next, the relationship between the reported data-distribution vector V(m) and the actual data-distribution vector Y(m) should be determined. Before this is done for the general case, it is illustrative to consider the relationship between V(1) and Y(1) for the specific case of the first ad (ad 1).

For the first ad, both V(1)=[Z₀(1),O₀(1)] and Y(1)=[ Z̅ₗ(1), Ōₗ(1)] are two-dimensional vectors. It can be seen that:

Pr[j∈T₀₀]=Pr[j∈T₀₀|j∈S₀₀[Pr[j∈S₀₀]+Pr[j∈T₀₀|j∈S₀₁]Pr[j∈S₀₁], and

Pr[j∈T₀₁]=Pr[j∈T₀₁|j∈S₀₀]Pr[j∈S₀₀]+Pr[j∈T₀₁|j∈S₀₁]Pr[j∈S₀₁], (9)

where the expression Pr[ ] indicates probability. Next, the conditional probabilities in Equations (9) should be expressed in terms of the parameters of the perturbation process. Assuming that all user devices use a fixed (p,γ)-pair perturbation mechanism, for a, b ∈{0,1}, the following expressions can be written:

$$\begin{matrix}Pr [ j ∈ {T}_{0 b} \vert j ∈ {S}_{0 a} ] = Pr [ {D}_{1 j} = b \vert {A}_{1 j} = a ] & ( 10 ) \\ = {φ}_{ab} , \\ where \text{:} & ( 11 ) \\ {φ}_{11} = p + ( 1 - p ) γ , \\ {φ}_{10} = ( 1 - p ) ( 1 - γ ) , \\ {φ}_{01} = ( 1 - p ) γ , and \\ {φ}_{00} = p + ( 1 - p ) ( 1 - γ ) . & ( 12 )\end{matrix}$$

The above relationships follow directly from the definition of the (p,γ)-pair privacy-preservation mechanism. For example, φ₀₁ is the probability that a user device that has a zero in some component of its A-vector reports the value of zero as a value of 1. This occurs, e.g., if there is the first coin toss (with probability 1−p) results in tails, and the second coin toss (with probability γ) results in heads. Since the coin tosses are independent, the probability of both of these events occurring is (1−p)γ. Similar arguments can be used to derive the other values for φ_{ab}. Equations (9) can be rewritten as:

$$[ \begin{matrix}{φ}_{00} & {φ}_{10} \\ {φ}_{01} & {φ}_{11}\end{matrix} ] [ \begin{matrix}{\overline{Z}}_{0} ( 1 ) \\ {\overline{O}}_{0} ( 1 )\end{matrix} ] = [ \begin{matrix}{Z}_{0} ( 1 ) \\ {O}_{0} ( 1 )\end{matrix} ] . \qquad ( 13 )$$

Defining a matrix M(1), which is independent of any actual data and can therefore be pre-computed, as:

$$M ( 1 ) = [ \begin{matrix}{φ}_{00} & {φ}_{10} \\ {φ}_{01} & {φ}_{11}\end{matrix} ] . \qquad ( 14 )$$

Equations (13) can be rewritten as:

M(1)Y(1)^{T}=V(1)^{T},

which yields the relationship between reported-data distribution V(1) and true-data distribution Y(1). This expression can be rewritten as V(1)^{T}=M(1)⁻¹Y(1)^{T}, where:

$${M}^{- 1} ( 1 ) = \frac{1}{{φ}_{00} {φ}_{11} - {φ}_{01} {φ}_{10}} [ \begin{matrix}{φ}_{11} & - {φ}_{10} \\ - {φ}_{01} & {φ}_{00}\end{matrix} ] . \qquad ( 15 )$$

The set of viewers who view the first ad is the set of users j with Λ₁ⱼ=1. The probability that a user has this property (or using a frequency interpretation, the fraction of users who have this property) is O₀(1). Therefore, solving for O₀(1) yields O₀(1)=W(1)Y(1)^{T}, where:

$$W ( 1 ) = [ - \frac{{φ}_{01}}{{φ}_{00} {φ}_{11} - {φ}_{01} {φ}_{10}} , \frac{{φ}_{00}}{{φ}_{00} {φ}_{11} - {φ}_{01} {φ}_{10}} ]$$

is the last row of M⁻¹(1). Substituting the expressions from Equations (12) yields:

$$W ( 1 ) = [ - \frac{( 1 - p ) γ}{p} , \frac{p + ( 1 - p ) γ}{p} ] .$$

Therefore, the estimated number of users who see ad 1 is expressed by:

\hat{N}₁=NO₀(1)=NW(1)Y(1)^{T}.

It is noted that the estimate for N₁ has been expressed in terms of a linear combination of the elements of reported-data distribution vector Y(1). Therefore (ignoring factor N), W(1) is the weighting vector, which has the following characteristics: (i) weighting vector W(1) depends only on the parameters of the privacy-preserving mechanism; (ii) weighting vector W(1) is independent not only of the reported Dᵢⱼ values but also independent of the identity of ad 1; (iii) weighting vector W(1) can be pre-computed once the privacy-preserving mechanism is determined, and (iv) the complexity of computing weighting vector W(1) is effectively equivalent to inverting a 2×2 matrix.

The estimation process can be adapted to the case of randomized perturbation, as follows. Since user devices choose the value of p from a common distribution function and choose the value of γ independently from a (perhaps different) common distribution function, the only change to make in the estimation process is to take into account the expected values for the elements of matrix M. If p is chosen from a density function p(p), and γ is chosen from a density function ω(γ), then the following expression results:

$$\overline{M} ( 1 ) {Y ( 1 )}^{T} = {V ( 1 )}^{T} , \\ where \text{:}$$

$$\overline{M} ( 1 ) = [ \begin{matrix}E [ {φ}_{00} ] & E [ {φ}_{10} ] \\ E [ {φ}_{01} ] & E [ {φ}_{11} ]\end{matrix} ] , \qquad ( 16 )$$

with the E[ ] expressions representing expected values that can be computed by integrating the values, e.g.,:

E[φ₀₁]=∫₀¹∫₀¹(1−p)γp(p)ω(γ)∂p∂γ.

Since p and γ are independent, and the function is linear in p and γ, it can be seen that:

E[φ₀₁]=(1− p̅) γ̅.

The elements of matrix M(m) for m>1 will be non-linear in p and γ. Therefore, the integration should be performed either analytically or numerically in order to get the expected values of the elements in the matrix. However, even in the case where p and γ are chosen from a distribution, matrix M(1) depends only on the parameters of the privacy-preserving mechanism (and not actual data) and therefore can be pre-computed.

The more-general case of estimating the number of users who view ad m generally follows the same steps as the procedure for the first ad, described above. Although the matrix expressions become more complex, as will be described in further detail below, the principle remains the same.

For the general case of estimating the number Nₘ of users who view ad m, actual-distribution vector V(m)=[Z(m), O(m)] is estimated from reported-distribution vector Y(m)=[ Z̅ₗ(m), Ōₗ(m)]. It is noted that both V(m) and Y(m) are 2m-dimensional vectors. An equation analogous to Equation (9) is used, and the value of O₀(m) is estimated, since that value represents the fraction of users who view ad m. Accordingly, for 0≦l≦m−1 and a,b=0,1:

$$Pr [ j ∈ {T}_{la} ] = {\sum }_{b = 0}^{1} {\sum }_{k = 0}^{m - 1} Pr [ j ∈ {T}_{la} \vert j ∈ {S}_{kb} ] Pr [ j ∈ {S}_{kb} ] . \qquad ( 17 )$$

A 2m×2m matrix M(m) is defined as follows:

$${M}_{uv} ( m ) = \{ \begin{matrix}Pr [ j ∈ {T}_{u 0} \vert j ∈ {S}_{v 0} ] u \leq m , v \leq m \\ Pr [ j ∈ {T}_{u 0} \vert j ∈ {S}_{v 1} ] u \leq m , v > m \\ Pr [ j ∈ {T}_{u 1} \vert j ∈ {S}_{v 0} ] u \leq m , v > m \\ Pr [ j ∈ {T}_{u 1} \vert j ∈ {S}_{v 1} ] u > m , v > m\end{matrix} ,$$

and the following Theorem (2) is applied:

Theorem (2): If all user devices employ a (p,γ) privacy-preserving mechanism, then:

$$Pr [ j ∈ {T}_{la}^{m} \vert j ∈ {S}_{kb}^{m} ] = {\sum }_{w = 0}^{min ( m , l )} ( \begin{matrix}k \\ w\end{matrix} ) ( \begin{matrix}m - 1 - k \\ l - w\end{matrix} ) {φ}_{11}^{w} {φ}_{10}^{k - w} {φ}_{01}^{l - w} {φ}_{00}^{m - 1 - k - l + w} {φ}_{ab} , \qquad ( 18 )$$

where _{ab}is defined as set forth in Equations (12) above.

As in the case of determining the number of users for the first ad, Equation (17) can be rewritten in matrix form as:

M(m)Y(m)^{T}=V(m)^{T}.

It is noted that matrix M(m) is independent of the data and can therefore be pre-computed. The inverse M⁻¹(m) of matrix M(m) can then be computed and substituted into the following expression:

Y(m)^{T}=M⁻¹(m)V(m)^{T}.

The variable W(m), which represents a weighting vector for ad m, is the m+1^{th} row of matrix M⁻¹(m) and is a 2m-dimensional vector. As with matrix M(m), vector W(m) is independent of the data and can be pre-computed. From the data, the following expression results:

O₀(m)=W(m)V(m)^{T},

and the following Theorem (3) can be used to calculate a variance for the estimate of the number of users for a given ad m:

Theorem (3): If all of the user devices in the system use a (p,γ) privacy-preserving mechanism, V(m) represents the 2m-dimensional reported-distribution vector, and W(m) is the 2m-dimensional weight vector for ad m, then:

\hat{N}ₘ=NW(m)V(m)^{T}.

The following expressions are also true:

E[\hat{N}ₘ]=Nₘ, and

Var[\hat{N}ₘ]=N(W²(m)V(m)^{T}−(m)V(m)^{T}]²).

The fact that E[\hat{N}ₘ] is equal to Nₘ follows directly from the derivation of weighting vector W(m). Reported-distribution vector V(m) can be viewed as a probability-density function and is a random weighting of weighting vector W(m), which results in the expression for calculating the variance set forth above.

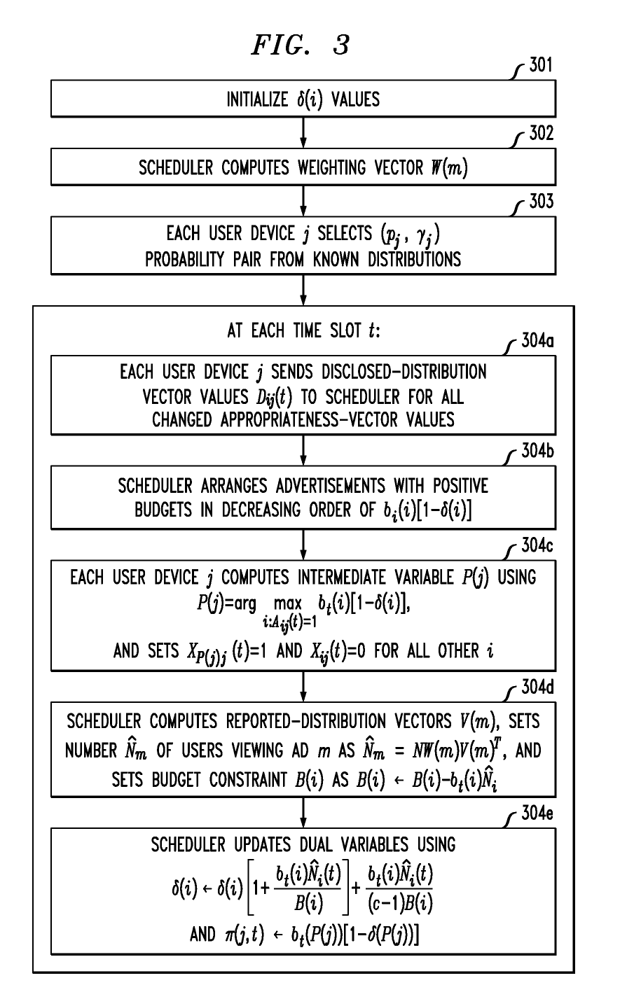

FIG. 3 is a flowchart outlining an exemplary privacy-preserving scheduling scheme consistent with one embodiment of the present invention. As shown, at step 301, the values of δ(i) are initialized to 0, for all values of i, at t=1. Next, at step 302, the scheduler computes weighting vector W(m) for 1≦m≦n, as described in further detail above. Next, at step 303, each user device selects its (pⱼ,γⱼ) probability pair from known distributions. Next, for each time slot t, the following steps 304a-304e are performed. At step 304a, each user device j∈S(t) sends, to the scheduler, disclosed-distribution vector values Dᵢⱼ(t) for all changed appropriateness-vector values Aᵢⱼ(t). At step 304b, the scheduler arranges the ads having positive budgets in decreasing order of bᵢ(i)[1−δ(i)]. At step 304c, user j's device computes intermediate variable P(j) using:

$$P ( j ) = arg {max}_{i \text{:} {A}_{ij} ( t ) = 1} {b}_{t} ( i ) [ 1 - δ ( i ) ] ,$$

and sets X_{P(j)j}(t)=1 and Xᵢⱼ(t)=0 for all other i. At step 304d, the scheduler computes reported-distribution vectors V(m) for 1≦m≦n, as described in further detail above, sets the number \hat{N}ₘ of users viewing ad m as \hat{N}ₘ=NW (m)V(m)^{T}, and sets budget constraint B(i) as B(i)←B(i)−bₗ(i) \hat{N}ᵢ. Lastly, at step 304e, the scheduler updates dual variables δ(i) and π(j,t) using:

$$δ ( i ) ← δ ( i ) [ 1 + \frac{{b}_{t} ( i ) {\hat{N}}_{i} ( t )}{B ( i )} ] + \frac{{b}_{t} ( i ) {\hat{N}}_{i} ( t )}{( c - 1 ) B ( i )} ,$$

and π(j, t)←bₜ(P(j))[1−δ(P(j))], respectively.

### Alternative Embodiments

It should be understood that appropriate hardware, software, or a combination of both hardware and software is provided, both at the user device's location and at a service provider's location (typically, but not necessarily remote from the user device's location), to effect the processing described above, in the various embodiments of the present invention. It should further be recognized that a particular embodiment of the present invention might support one or more of the modes of operation described herein, but not necessarily all of these modes of operation.

Although embodiments of the invention are described herein in the context of a “user” being a single person using a single “user device” in a given household, it is likely that more than one individual will share an Internet connection and/or TV services with other individuals in the same household (or, similarly, e.g., that more than one worker at a place of business will share an Internet connection with co-workers). One way of handling this scenario is to treat all of the individuals as a single user, such that only a single set of keywords is collected to create a single user profile for a household, irrespective of the individual performing the Internet searching, and all ads that are scheduled are based on those keywords, irrespective of the individual who actually views those ads. Alternatively, along with the Internet search keywords, additional criteria may be received that can be used to identify which individual is performing a search (e.g., a username used to log into a search engine, an IP address of a particular computer on the home network, etc.) so that multiple user profiles can be created for a single household or other physical network location Similar criteria can be used to identify which individual is viewing TV, e.g., an IP address (or other identification) of a set-top box of a particular television on the home network, or examination of past viewing habits to determine which individual is most likely watching TV based on the current channel being watched, the time/date television is being watched, the type or content of the program being watched, etc. Accordingly, the terms “user” and “user device” should be understood to include both single-user devices (e.g., mobile phones, televisions, or PCs) and multiple-user devices (e.g., televisions, set-top boxes, PCs, network servers, or residential gateways). The term “user device” should also be understood to include embodiments where a “user device” is a single physical device (e.g., a PC or set-top box), as well as embodiments where a “user device” includes multiple physical devices (e.g., a residential gateway coupled with a set-top box and a television; a network server coupled to a PC; or a mobile phone coupled to a wireless hub). Additionally, embodiments of the present invention can involve (i) a user having only a single profile used in connection with a single user device, or alternatively, (ii) a user having multiple profiles used in connection with multiple user devices, or (iii) a user having a single profile that is used with multiple user devices.

The terms “viewer” and “user” are used interchangeably herein and are defined to include a person who conducts an Internet session, e.g., a web browsing session or a search engine session, as well as a person who receives packet-based media content by watching TV, IPTV, listening to IP radio, etc. The singular terms “viewer” and “user” are also used herein to refer collectively to a group of individuals, such as members of a family living in one household, in which case a scheme consistent with embodiments of the invention might not be able to determine which of these individuals is watching TV or conducting an Internet session, and therefore, all possible individuals are treated as a single viewer, e.g., for purposes of keyword collection and/or ad placement, without regard to which or how many of these individuals are actually performing these activities.

Although the ads described herein are video ads in a TV system or Internet Protocol TV (IPTV) system containing broadcast programming, on-demand programming, and/or recorded (e.g., digital-video recorder) programming, the invention may also have utility in placing ads in other media, e.g., audio ads in an IP radio system, video ads in an on-demand video system, video ads in an Internet- or web-delivered video system, or audio or video ads in a cellular telephony-based on-demand and/or streaming media system. The term “programming” should be broadly construed to include all of the foregoing. The term “media,” as used herein, should therefore be understood to include audio-only content, video-only content, and content containing both audio and video.

Embodiments of the invention are set forth herein wherein ads are described as being “pre-loaded” onto a user device, such as a set-top box, residential gateway, network server, or mobile phone. It should be understood that the present invention also includes embodiments in which the ads themselves are pre-loaded onto a different device (e.g., a secure remote server), such that only a list of ads is pre-loaded onto the user device. In this scenario, the ads could be downloaded on demand by, or streamed on demand to, a user device, such as a TV, set-top box, or mobile phone, to be shown to a viewer during a timeslot.

The term “match,” as used herein in connection with comparing keywords from ad bids and keywords from a viewer's Internet session to place a bid for an ad during a time slot, should be construed broadly to refer not only to exact, character-for-character keyword matches, but also to fuzzy-logic matches, i.e., matches made based on the most-probable word or phrase match when no character-for-character keyword match exists. Matching, in the context of the present invention, should also be construed to include non-exact keyword matching and matching based on any other criteria and algorithms, e g , using synonym-based, related-term-based or concept-based keyword matching.

The term “random,” as used herein, should not be construed as being limited to pure random selections or pure random number generations, but should be understood to include pseudo-random, including seed-based selections or number generations, as well as other selection or number generation methods that might simulate randomness but are not purely random. Accordingly, functions used to generate perturbed vectors, as used in embodiments of the present invention, may be based on random numbers, non-random numbers, or combinations of random and non-random numbers. Further, perturbed vectors can be generated using one or more random numbers as described herein, as well as using one or more random numbers in connection with other algorithms not specifically described herein.

Although embodiments of the invention described herein are described as estimating the number of viewers for a given ad after the timeslot during which the ad was shown, it should be understood that, in some embodiments of the invention, this estimate could be made during the timeslot while the ad is being shown, or even prior to the timeslot in which the ad is actually shown, assuming sufficient data exists to generate the perturbed vectors employed in arriving at such an estimation.

It should be understood that various changes in the details, materials, and arrangements of the parts which have been described and illustrated in order to explain the nature of this invention may be made by those skilled in the art without departing from the scope of the invention. For example, it should be understood that the inventive concepts of embodiments of the invention may be applied not only in systems for mapping household assets, as described above, but also in other systems involving the mapping of business assets and other financial data.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor, the program code segments combine with the processor to provide a unique device that operates analogously to specific logic circuits.

It will be appreciated by those skilled in the art that although the functional components of the exemplary embodiments of the system of the present invention described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, the system of the present invention may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, Google Chrome™, or Apple Safari™). Thus, the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Microsoft Windows NT/2000™ or UNIX.

Components of a system consistent with embodiments of the invention may include mobile and non-mobile devices. Mobile devices that may be employed in the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1xRTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to the present invention. These personal computers may run the Unix, Microsoft Windows NT/2000™ or Windows 95/98/NT/ME/CE/2000/XPNista/7™ operating systems. The aforesaid functional components of a system according to the present invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to the present invention may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality (e.g., as part of a multifaceted telephone, Internet, and television system operated by a home optical-fiber network service provider).

In one embodiment, source code may be written in an object-oriented programming language using relational databases. Such an embodiment may include the use of programming languages such as C++ and toolsets such as Microsoft's .Net™ framework. Other programming languages that may be used in constructing a system according to the present invention include Java, HTML, Perl, UNIX shell scripting, assembly language, Fortran, Pascal, Visual Basic, and QuickBasic. Those skilled in the art will recognize that the present invention may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The singular terms “computer” or “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be further understood that various changes in the details, materials, and arrangements of the parts which have been described and illustrated in order to explain the nature of this invention may be made by those skilled in the art without departing from the scope of the invention as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

We claim:

1. A computer-implemented method for estimating the number of user devices, from among a set of user devices, showing a target advertisement from among a plurality of candidate advertisements during a timeslot, the method comprising:
(a) the computer sending, to each of the user devices in the set, identification of the plurality of candidate advertisements capable of being shown during the timeslot by the user device;
(b) the computer receiving data from a plurality of the user devices, wherein:
(i) the number of user devices showing the target advertisement from among the plurality of candidate advertisements during the timeslot is capable of being estimated based on the data received from the plurality of user devices; and
(ii) the identity of the user devices showing the target advertisement during the timeslot is incapable of being determined based on the data received from the plurality of user devices; and
(c) the computer estimating, based on the data received from the plurality of user devices, the number of user devices showing the target advertisement during the timeslot.

2. The invention of claim 1, wherein step (a) further comprises the computer sending, to each of the plurality of user devices in the set, the content of the candidate advertisements.

3. The invention of claim 1, wherein step (a) further comprises the computer ordering the candidate advertisements so as to maximize revenue, prior to sending identification of the plurality of candidate advertisements to the user devices.

4. The invention of claim 1, wherein the data received from each user device is a Boolean vector.

5. The invention of claim 1, wherein the data received from each user device is generated based on appropriateness, for the user corresponding to the user device, of one or more of the candidate advertisements.

6. The invention of claim 1, wherein the data received from each user device is generated using information perturbed based on one or more randomly-generated values.

7. The invention of claim 1, wherein the data received from each user device is generated based on one or more keywords of a user profile.

8. A user device-implemented method for generating data for estimating the number of user devices, from among a set of user devices, showing a target advertisement from among a plurality of candidate advertisements during a timeslot, the method comprising:
(a) the user device receiving identification of the plurality of candidate advertisements capable of being shown during the timeslot by the user device;
(b) the user device generating data, wherein:
(i) the number of user devices, from among the set of user devices, showing the target advertisement from among the plurality of candidate advertisements during the timeslot is capable of being estimated based on the data from a plurality of the user devices; and
(ii) the identity of the user devices showing the target advertisement during the timeslot is incapable of being determined based on the data from the plurality of the user devices; and
(c) the user device providing the data to a computer adapted to estimate, based on the data from the plurality of user devices, the number of user devices showing the target advertisement during the timeslot.

9. The invention of claim 8, wherein step (a) further comprises the user device receiving the content of the candidate advertisements.

10. The invention of claim 8, wherein step (b) further comprises:
(b1) the user device selecting the target advertisement from among the candidate advertisements; and
(b2) the user device showing the target advertisement.

11. The invention of claim 8, wherein the data is a Boolean vector.

12. The invention of claim 8, wherein the user device generates the data based on appropriateness, for the user corresponding to the user device, of one or more of the candidate advertisements.

13. The invention of claim 8, wherein the user device generates the data using information perturbed based on one or more randomly-generated values.

14. The invention of claim 8, wherein the user device generates the data based on one or more keywords of a user profile.

15. A system comprising:
a computer; and
a set of user devices in communication with the computer, wherein:
the computer is adapted to:
(i) send, to each of the user devices in the set, identification of a plurality of candidate advertisements capable of being shown during a timeslot by the user device; and
(ii) receive data from a plurality of the user devices;
the number of user devices, from among the set of user devices, showing a target advertisement from among the plurality of candidate advertisements during the timeslot is capable of being estimated based on the data from the plurality of user devices; and
the identity of the user devices showing the target advertisement during the timeslot is incapable of being determined based on the data from the plurality of user devices; and
the computer is adapted to estimate, based on the data from the plurality of user devices, the number of user devices showing the target advertisement during the timeslot.

16. The invention of claim 15, wherein the computer is further adapted to send, to each of the plurality of user devices in the set, the content of the candidate advertisements.

17. The invention of claim 15, wherein the computer is further adapted to order the candidate advertisements so as to maximize revenue, prior to sending identification of the plurality of candidate advertisements to the user devices.

18. The invention of claim 15, wherein each user device is adapted to:
select the target advertisement from among the candidate advertisements; and
show the target advertisement.

19. The invention of claim 15, wherein each user device is adapted to generate the data in the form of a Boolean vector.

20. The invention of claim 15, wherein each user device is adapted to generate the data based on appropriateness, for the user corresponding to the user device, of one or more of the candidate advertisements.

21. The invention of claim 15, wherein each user device is adapted to generate the data using information perturbed based on one or more randomly-generated values.

22. The invention of claim 15, wherein each user device is adapted to generate the data based on one or more keywords of a user profile.
